(19) United States
(12) Patent Application Publication
(10) Pub. No.: US 2002/0175446 A1
(43) Pub. Date: Nov. 28, 2002

(54) Injection mold inner core die and method of use

(76) Inventor: Edward J. Friery, Coalville, UT (US)

Correspondence Address: Sally J. Brown, Autoliv ASP, Inc., 3350 Airport Road, Ogden, UT, 84405, US

(21) Appl. No.: 09/864,965

(22) Filed: May 24, 2001

(51) Int. Cl. B29C 45/40

(52) U.S. Cl. 264/328.1; 249/174; 425/468; 264/334

(57) ABSTRACT

An injection mold inner core die is disclosed that uses no additional moving parts and decreases fabrication time required for injection molded pieces such as airbag covers. The injection mold inner core die allows for cost effective revising and re-tooling of the die. The inner core die includes one or more window mold members that extend from the surface of the inner core die. The window mold member is shaped to form a window in solidified injection mold material once the mold is closed. The window mold member includes a pair of parallel ramps that provide a pair of inclined planes for separating material contacting the surface of the inner core die. The inclined planes created by the ramps allows the material to travel up the ramps and frees the material from the window mold member. The ramps run from the surface of the inner core die to the top of the window mold member in a direction in which the molded piece is to be automatically moved for removal from the inner core die. The window mold member may include a boss positioned between the ramps to further assist in separating and lifting the material away from the surface to free a window in the molded piece from the window mold member.

### BACKGROUND OF THE INVENTION

1. The Field of the Invention

The present invention relates to injection molds. More specifically, the invention relates to an airbag injection mold inner core die for facilitating removal of a fabricated airbag cover from the inner core die.

2. Technical Background

Fabrication through molding is an established industry. Injection molding generally means a mold material is placed or injected into a mold by force. The material is then hardened. The molded part is removed and an object in the shape of the mold is created.

Injection molding may use various different materials and hardening techniques. For example, metal objects may be molded by filling a mold with molten metal, allowing the metal to cool, and then removing the molded object from the mold. In pottery, the material is placed in the mold and then the mold is often fired to harden the material.

Today, injection molding is often used in the manufacturing of various plastic objects including toys, containers, baskets, and the like. Modem injection molding materials include plastic, rubber, and other composite materials. These and other materials are often used in fabricating injection molded parts for various machines including vehicles. For example, airbag covers used in conventional airbag systems are generally made through injection molding.

Generally, an injection mold includes a top half and a bottom half. Alternatively, the division between top and bottom may not lie at the half way point. Generally, each half includes a pattern in the surface. The pattern may be concave or convex and includes an contour of peaks and valleys. The pattern forms an inverse design of the pattern and shape of the surface of the molded object.

The mold may include an inner core die. An inner core die generally cooperates with the top or bottom of the mold to form a distinct pattern or structure in a portion of the molded object. Often, an inner core die is used to form walls in the molded object. Walls are generally sections of the molded object that extend from the main body of the object.

The walls of a molded object may allow the object to serve functional purposes. For example, an airbag cover may be molded such that walls are formed on an installation side of the airbag cover. The walls may be used to secure the airbag cover to an airbag housing or mount fixed within a vehicle.

Generally, the walls include openings, referred to hereinafter as windows, to allow the wall to be secured using flanges that protrude from the side of an airbag housing. Generally, the windows should be well defined and have limited defects. Additionally, a single wall may require multiple windows to ensure proper securement of the airbag cover to the airbag housing. To ensure windows are formed in the proper location of walls and are of the proper quality, windows are generally formed by mold members that extend from a surface of the inner core die.

Generally, an airbag cover is a piece of plastic, rubber, or other semi-pliable composite that covers and holds other airbag components within an airbag housing. Additionally, the exterior surface of the airbag cover generally provides an aesthetic textured surface to disguise the main airbag components. Through injection molding, airbag covers may be formed that are functional and present visible aesthetic surfaces to a vehicle occupant.

Generally, mold members on the surface of a mold, particularly an inner core die, are effective in creating uniform operable windows in walls of the molded object. However, once the injection mold is filled with material, such as liquid rubber, the cooled and molded object must be removed from the mold without damaging the windows. Various techniques may be used for removal of the molded object including manual and automated.

Generally, the injection molding process is automated. Two halves of a mold are pressed together and separated using hydraulics and push rod lifters. Generally, when the molded object is cooled sufficiently to be removed from the mold, push rod lifters engage the molded object and move it perpendicularly away from a mold half.

However, if mold members are used to form windows, the molded object is often removed manually. The liquid injection material has solidified around the mold members. Generally, the windows are very small in comparison to the rest of the molded object. Therefore, as a rod attempts to move the molded object in a perpendicular direction away from a mold half, the protruding mold members forming the windows remain within the windows. If perpendicular push rods are used one or more of the windows may be torn by the mold members. Consequently, the wall should be separated from the wall and the windows prior to attempting removal from the inner core die. In this way, the molded object, such as an airbag cover may be removed without damaging the windows.

Manual removal is generally very difficult, error prone, requires special tools and/or limit automation. In the case of airbag covers, walls may connect to form a rectangle or square corresponding to the shape of an airbag housing. The walls are formed by an inner core die. The inner core die may include a plurality of protruding mold member to form windows. The airbag cover injection mold material is generally a very rigid rubber material. Additionally, the airbag cover must be removed with minimal window damage and minimal stress marks on the external surface of the airbag cover.

Given these fabrication requirements for airbag covers, separating all four walls from the inner core die at nearly the same time, or bending one wall and not damaging or severely stressing another wall is very difficult. To solve this problem, special tools are be used by the worker. These tools increase the time required to remove the airbag cover. Additionally, the hard rubber requires great physical strength from the worker to remove the airbag cover. This stress on the worker limits the number of airbag covers they can remove from a mold in one shift. These limitations may severely slow an assembly line process for fabricating a molded object such as an airbag cover.

Some solutions to this problem in airbag cover injection molding have been introduced. For example, one solution is to retract the mold members at the time in the fabrication process when the airbag cover is removed from the mold. In this manner, push rods may separate the airbag cover perpendicularly from a mold half.

However, this solution introduces more moving parts into the molding process. The additional parts are generally used to retract and extend the mold members. These parts are prone to damage, and wear. Down time to repair these parts may be significant.

Additionally, airbag covers are generally made in different styles to match the vehicle into which they will be installed. Often this means that a completely different mold is needed for each style of airbag cover. Each style of mold may require a different design for the inner core die. If moving parts are used to retract and extend mold members, a new costly design for the extension and retraction mechanism may be required for each design. Similarly, different designs for an inner core die may require different tools for manual removal of the airbag cover.

Accordingly, it would be an advancement in the art to provide an injection mold inner core die and method of use which allows for easy removal of the formed, molded piece. It would be a further advancement to provide an injection mold inner core die and method of use which is easy to design, revise, and fabricate to produce different molded pieces. Additionally, it would be an advancement in the art to provide an injection mold inner core die and method of use which allows easy removal without additional moving parts. Furthermore, it would be an advancement in the art to provide an injection mold inner core die and method of use which allows for formation of windows in the molded piece with minimal wear to the inner core die. The present invention provides these advancements in a novel and useful way.

### BRIEF SUMMARY OF THE INVENTION

The apparatus of the present invention has been developed in response to the present state of the art, and in particular, in response to the problems and needs in the art that have not yet been filly solved by currently available injection mold inner core dies. Thus, the present invention provides an injection mold inner core die which allows for easy removal of a molded piece, has fewer moving parts, and is easy to revise and re-design.

In one embodiment, the injection mold inner core die includes a window member projecting from a surface of the inner core die. Preferably, the injection mold inner core die is configured to define a window in an interior wall of a piece being molded. The window member includes a pair of ramps which slope outwardly from the surface of the inner core die. The ramps are configured to assist in separating the interior wall of the piece being molded from the surface when the molded piece and inner core die are separated. The injection mold inner core die may include a boss. The boss is preferably positioned on the surface between the ramps to further assist in separating the interior wall of the piece being molded from the surface.

In an alternative embodiment, the injection mold inner core die includes concave corners. The corners allow the molded piece to flex and bend more easily. The more an interior wall of the piece bends the more easily the interior wall may be separated from the surface by the ramps.

These and other features, and advantages of the present invention will become more fully apparent from the following description and appended claims, or may be learned by the practice of the invention as set forth hereinafter.

### BRIEF DESCRIPTION OF THE DRAWINGS

In order that the manner in which the above-recited and other advantages of the invention are obtained and may be readily understood, a more particular description of the invention briefly described above will be rendered by reference to specific embodiments thereof which are illustrated in the appended drawings. Understanding that these drawings depict only typical embodiments of the invention, and are not therefore to be considered to be limiting of its scope, the invention will be described and explained with additional specificity and detail through the use of the accompanying drawings in which:

FIG. 1A is a perspective view illustrating within a vehicle where passenger airbag apparatuses are generally installed.

FIG. 1B is a perspective view illustrating components of a passenger airbag apparatus after the airbag is inflated.

FIG. 2 is a perspective view illustrating a driver's side airbag housing and airbag cover.

FIG. 3 is a cross-sectional view illustrating an injection mold utilizing the present invention.

FIG. 4 is a perspective view illustrating an airbag cover, an injection mold, and an injection mold inner core die.

FIG. 5 is a perspective side view of a window mold member according to one embodiment of the present invention.

FIG. 6 is a perspective view illustrating a plurality of windows formed in a wall of a molded piece by an injection mold inner core die according to one embodiment of the present invention.

### DETAILED DESCRIPTION OF THE PREFERRED EMBODIMENTS

The present invention can be better understood with reference to the drawings where like parts are designated with like numerals throughout.

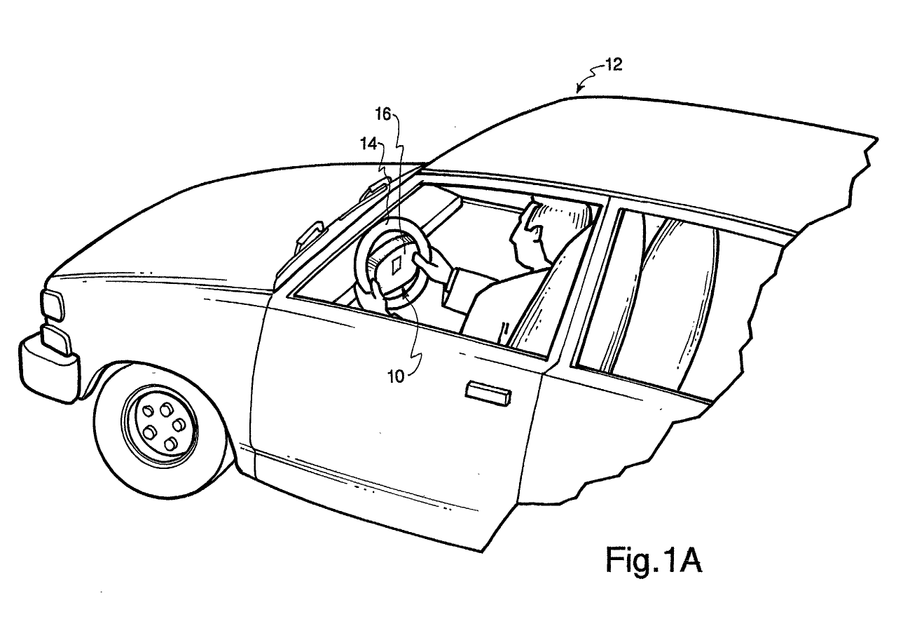

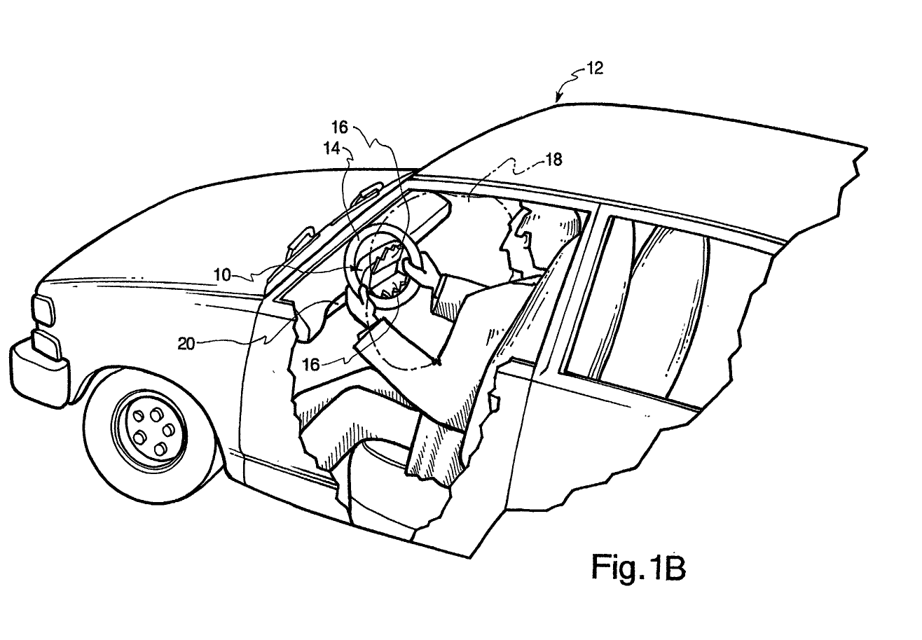

FIG. 1A is a perspective view illustrating where airbag apparatuses 10 are generally installed. FIG. 1A illustrates a conventional vehicle 12 equipped with a driver's side airbag apparatus 10. The illustrated vehicle 12 is a passenger car 12. The passenger car 12 includes a driver's side airbag apparatus 10 installed in the center of the steering wheel 14. Although a driver's side airbag apparatus 10 alone is illustrated, it is well understood that airbag apparatuses 10 in general may be installed in various locations inside a vehicle 12, including the dash board, lower leg area, roof rail, and the like.

Generally, airbag apparatuses 10 store air bag components behind an airbag cover 16. The airbag cover 16 conceals the components from vehicle occupants. Additionally, the airbag cover 16 also stores the components in a more compact area than would be possible without an airbag cover 16. Generally, the airbag cover 16 includes an exterior surface of the appropriate texture and color to match the interior texture and colors of the vehicle. The airbag cover 16 allows the airbag components to be effectively stored, concealed from view, and aesthetically appealing for the occupant.

FIG. 1B illustrates an airbag apparatus after the airbag 18 has inflated. Generally, airbags 18 are inflated using a pyrotechnic inflator (Not Shown). Due to the short time available and the volume of space an airbag 18 is required to occupy once inflated, the airbag 18 is inflated with a very high degree of force. To allow the airbag 18 to inflate the airbag cover 16 should not restrict proper inflation of the airbag 18. However, the airbag cover 16 can not generally reveal the airbag 18 in a short enough time. Therefore, the airbag 18 generally strikes the airbag cover 16 while inflating.

To allow the airbag 18 to continue inflating, the airbag cover 16 may be penetrated by the airbag 18 or moved out of the way of the airbag 18. In either case, the airbag 18 may accelerate the airbag cover 16 to a very high velocity such that the airbag cover 16 may become a dangerous projectile moving toward an occupant. Therefore, the airbag cover 16 is generally secured to prevent injury to the occupant from the airbag cover 16.

FIG. 1B, illustrates an airbag cover 16 secured to the steering column 20. In FIG. 1B, the airbag cover 16 has been penetrated by the inflating airbag 18. However, the airbag cover 16 remains secured to the steering column 20.

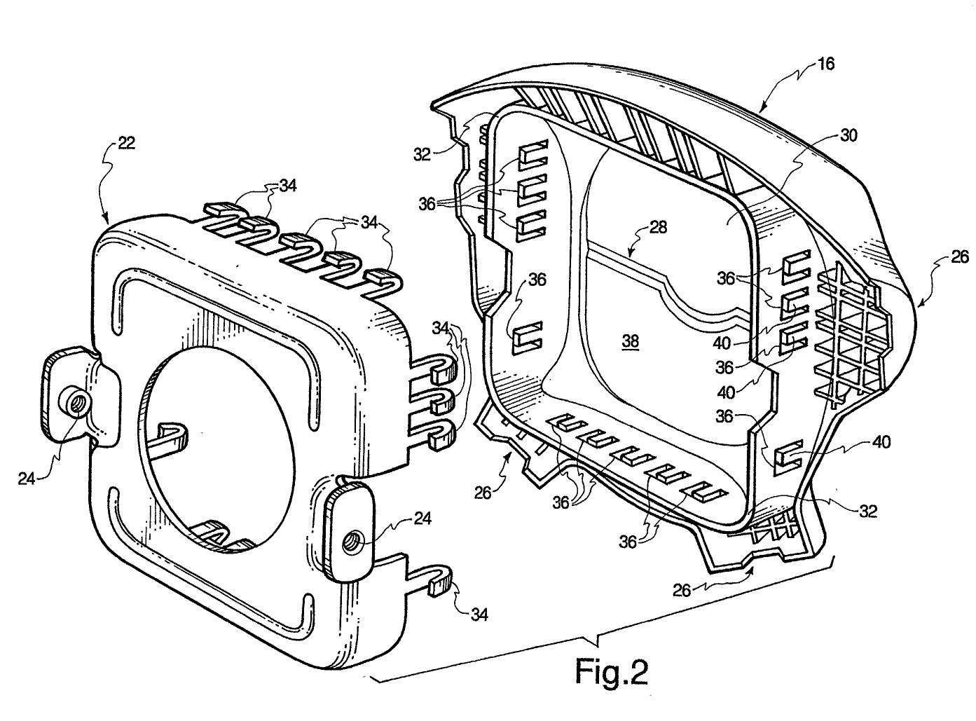

Securement of the airbag cover 16 to the steering column 20 may be accomplished through various techniques. FIG. 2, illustrates a preferred technique that utilizes no additional parts and is simple to assemble. This technique is a hook and window system described in more detail below.

In FIG. 2, an airbag housing 22 and an airbag cover 16 are illustrated. Although a housing 22 and airbag cover 16 designed for a driver's side airbag apparatus 10 are illustrated, it is contemplated that the aspects of the present invention are not limited to driver's side airbag apparatuses 10. Preferably, the housing 22 encloses the components of an airbag apparatus 10 and secures the same to the vehicle. In FIG. 2, the housing 22 is configured to secure to a steering column 20.

In the depicted embodiment, threaded holes 24 extending from the back of the housing 22 may be secured by threaded bolts (Not Shown) to the steering column 20. In this manner, the airbag apparatus 10 may be secured to the vehicle 12.

Due to the structural support the housing 22 should provide, the housing 22 is generally made of a rigid material such as metal, hard plastic, and the like. The housing 22 is sized to operably store the components of the airbag apparatus 10. The size of the airbag apparatus 10 may vary depending on the size, style, and design of the vehicle. Generally, the housing 22 is in the shape of a rectangle or a square.

Additionally, the housing 20 may store other components such as a vehicle horn button, cruise control wiring, or the like. Components such as a vehicle horn, airbag 18, and inflator (Not Shown) are not illustrated in FIG. 2 to avoid obscuring aspects of the present invention.

The airbag cover 16, as mentioned above, serves to enclose other components of the airbag apparatus 10 and provides an aesthetic front surface to a vehicle occupant. Generally, the airbag cover 16 is sized to conceal the airbag apparatus 10 as well as other structural members of the steering column 20. The airbag cover 16 may include one or more arms 26 that correspond to arms of the steering column 20.

Preferably, airbag covers 16 are made from semirigid rubber material. Other materials such as plastic, aluminum, or other semirigid, pliable material. Use of semirigid rubber provides the structural integrity necessary to enclose and store the components of the airbag apparatus 10. Semirigid rubber is also light weight which improves efficiency of the vehicle 12.

Two reasons why semirigid rubber is preferred relate to fabrication and operation of the airbag apparatus 10. First, with respect to operation, the airbag cover 16 may include a tear seam 28. A tear seam 28 is generally one or more lines in the airbag cover 16 that are more thin than the remainder of a front portion 30 of the airbag cover 16. Often a tear seam 28 is embodied as a groove 28 in the front portion 30. The tear seam 28 is positioned such that the force of an inflating airbag 18 will break through the front portion 30 and continue to inflate to protect the occupant. If the airbag cover 16 is made of semirigid rubber, then the tear seam 28 need not be as thin as with other materials such as metal. Additionally, rubber reduces the risk the airbag 18 will be punctured by the front portion 30 during inflation.

Second regarding fabrication, airbag covers 16 made from semirigid rubber lend themselves easily to fabrication using an injection molding method. A plurality of airbag covers 16 may be fabricated in assembly line fashion using an injection molding machine. Additionally, injection molding allows for a texture and/or design to be placed on the front surface of the airbag cover 16. The injection mold need only be designed and built once to provide for fabrication of a plurality of airbag covers 16.

Due to the advantages of using semirigid rubber, it is preferable to fabricate airbag covers with an injection molding machine. Therefore, the airbag covers 16 will be referred to herein as molded airbag covers 16, molded pieces 16, as well as simply airbag covers 16.

Referring still to FIG. 2, in a preferred embodiment, the molded airbag cover 16 is secured to the housing using a hook and window system. A hook and window system is preferred when the airbag 18 penetrating the molded airbag cover 16 may break the molded airbag cover 16 into a plurality of pieces. The molded airbag cover 16 may include an interior wall 32. The interior wall 32 provides support structure to secure the molded airbag cover 16 to the housing 22.

Generally, the interior wall 32 is sized to circumscribe the sides of the housing 22. Alternatively, the interior wall 32 may be just smaller than the housing 22. Preferably, the housing 22 is rectangular or square in shape requiring the interior wall 32 to have four corresponding sides. Alternatively, the housing 22 and correspondingly the interior wall 32 may have different geometric shapes including that of an oval, circle, triangle, and the like.

Preferably, the molded airbag cover 16 is secured to the housing 22 by a plurality of hooks 34. The molded airbag cover 16 also includes a corresponding plurality of windows 36 to receive the hooks 34. The hooks 34 are disposed along the outside edge of the sides of the housing 22. The windows 36 are disposed within the interior wall 32 and positioned to receive a hook 34. The hooks 34 and windows 36 may be of various configurations and sizes. A plurality of hooks 34 and windows 36 around the housing 22 ensure that portions of the molded airbag cover 16 do not become separate projectiles when an airbag 18 penetrates the molded airbag cover 16.

Embodiments of the present invention described herein relate specifically to the formation of windows 36 within molded airbag covers 16. However, it is contemplated that embodiments of the present invention may be used in molding windows 36 of various shapes and sizes in different molded pieces. Windows and the present invention may be useful in other arts using injection molding to fabricate parts and components, including toy manufacturers, consumer electronics component manufacturers, and the like.

In FIG. 2, the airbag cover 16 is attached by positioning the housing 22 within the cavity 38 of the molded airbag cover 16. The hooks 34 are then inserted into the windows 36. Next, the molded airbag cover 16 is pulled away from the housing 22 such that the hooks 34 engage a portion of the interior wall 32.

In a preferred embodiment, the windows 36 include tabs 40. The tabs 40 are preferably made from the same semirigid material as the molded airbag cover 16. Preferably, the tabs 40 are a portion of the interior wall 32 that extend into the window 36 to form a window 36 having a block “U” shape.

Tabs 40 serve to further secure the hooks 34 within the windows 36. Once the airbag cover 16 is installed on the housing 22, the tabs 40 prevent the hooks 34 from substantial movement within the windows 36 to ensure complete securement. The tabs 40 also aid when installing the airbag cover 16. Because the tabs 40 are made of the same pliable material as the airbag cover 16, the tabs 40 may be bent out of the window 36 to allow insertion or removal of the hooks 34. The nature of the tab material allows the tab 40 to spring back into the window 36 once the hook 34 is positioned.

Generally, a plurality of windows 36 formed in the airbag cover 16 is preferred to provide the securement necessary to allow the inflating airbag 18 to penetrate the airbag cover 16. Conventionally, as mentioned above, airbag covers 16 are made using an injection mold. However, as the number of windows 36 increases so does the complexity of the mold required to properly form all the windows 36. With conventional injection molding, each window 36 may require one or more moving parts be added to the mold. Similarly, the smaller the windows 36, the more complex conventional molds must be to properly form the windows 36.

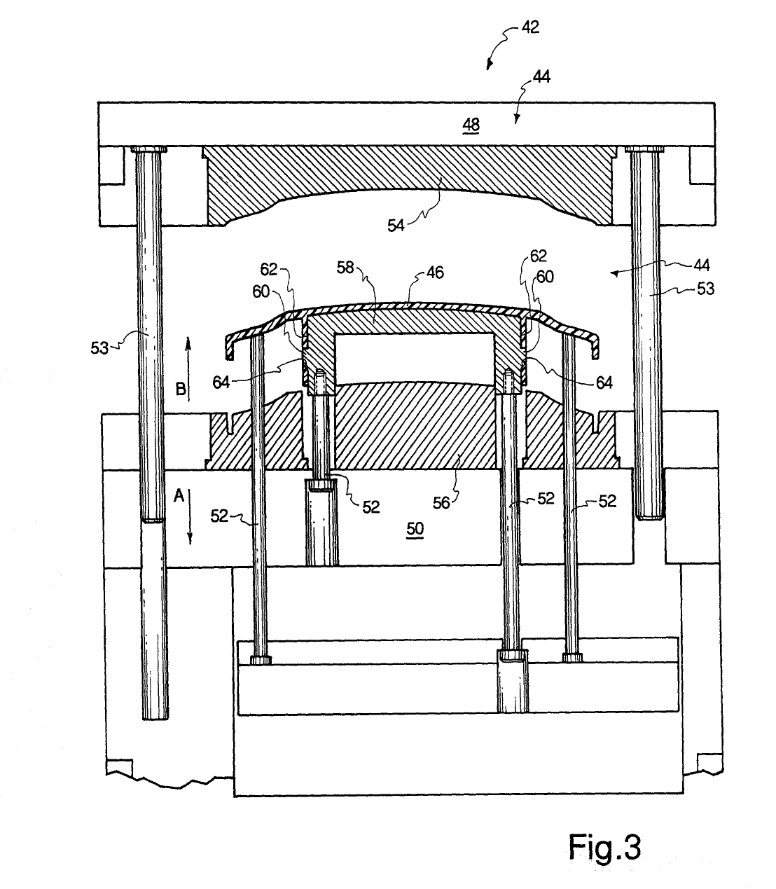

FIG. 3 illustrates a cross-section view of portions of an injection mold machine 42. The injection mold machine 42 generally includes an injection mold 44 according to the present invention. Preferably, the injection mold 44 used to fabricate a first type of molded piece 46 (e.g. molded airbag cover 16) may be easily replaced by another injection mold 44 configured to fabricate a second type of molded piece 46. In this manner, the injection mold machine 42 may be used to produce a plurality of molded pieces 46 according to the particular injection mold 44 being used.

An injection mold machine 42 is generally a machine for securing two or more pieces of the injection mold 44 together to allow fabrication of a molded piece 46. The injection mold machine 42 includes a top 48 and a bottom 50. The top 48 and bottom 50 may be closed using various mechanical devices such as hydraulic presses, lever presses, and other such mechanisms. The top 48 and bottom 50 may be separated using one or more rods 52. The rods 52 may be driven by hydraulics, levers, or other driving mechanisms. Generally, injection machine 42 components such as the top 48, bottom 50, and rods 52 are made from metal to provide reliability and endurance. Alternatively, material such as wood, ceramic and the like may be used.

Generally, the injection mold 44 includes a top 54 and a bottom 56. The top 54 is secured to the top 48 of the injection mold machine 42. The bottom 56 is secured to the bottom 50 of the injection mold machine 42. Generally, the top 54 and bottom 56 of the injection mold 44 are made from steel. Alternatively, materials such as wood, stone, ceramic, hard plastic, metal alloys and the like may also be used.

The contour of the top 54 and bottom 56 depends on the desired shape and contour of the molded piece 46. The contour of the mold represents the inverse of the desired contour for the molded piece 46. If the top of the piece 46 is to have a textured surface then the top 54 will have hills and valleys positioned to create the desired texture. Similarly, the top 54 may include mold structures necessary to create a design on the surface of the molded piece 46.

FIG. 3 illustrates a piece 46 requiring that an interior wall 32 be formed on the bottom (from the perspective illustrated in FIG. 3) of the piece 46. Alternatively, an interior wall 32 may be desired on the top of the piece 46. In either case, an inner core die 58 may be used to form the interior wall 32. In FIG. 3, the inner core die 58 is positioned within the bottom 56 of the injection mold to form an interior wall 32.

Generally, an inner core die 58 is a separate member from the top 54 or bottom 56 of the injection mold 44. Use of an inner core die 58 allows interior walls 32 to be formed and provides a mechanism for easier removal of the molded piece 46 than if an inner core die 58 is not used.

An inner core die 58 is advantageous because rods 52 may be used to lift the inner core die 58 and molded piece 46 away from the bottom 56. This allows the molded piece 46 to be more easily removed from the injection mold 44. The rods 52 separate the molded piece 46 from a majority of the mold 44. The molded piece 46 is then only attached to the inner core die 58. Preferably, rods 52 are then used to lift the molded piece 46 from the inner core die 58.

The type of injection mold material can impact the ability to use rods 52 to remove the molded piece 46. Additionally, forming interior walls 32 using grooves in the bottom 56 rather than an inner core die 58 can limit the ability of the injection machine 42 to use rods 52 to remove the molded piece 46. For example, semirigid rubber is generally used in molds 44 for airbag covers 16. The airbag cover molds 44 are generally made from steel. The cured and solidified rubber may be very difficult to remove from a bottom 56 having deep grooves to form the interior walls 32.

In conventional injection molding, a liquid mold material is injected under pressure into a space defined by the mold top 54, bottom 56, and inner core die 58. Due to the pressure used to drive the liquid mold material into the mold 44, forming a window 36 requires that a first part of the mold meet flush with a second part of the mold. Close contact prevents injected material from depositing where a window 36 is desired.

Preferably, a window mold member 60 is used ensure the close contact and form a window 36.

Referring still to FIG. 3, a window mold member 60 may be disposed along the surface 62 of the inner core die 58. The window mold member 60 meets flush with another portion such as the bottom 56 of the mold 44 to form a window 36. The window 36 is formed by the absence of injection mold material.

One process of forming a molded piece 46 through injection molding will now be described to explain some of the difficulties faced in the art and aspects of the present invention that overcome the limitations of conventional injection molding. First the mold 44 is closed by moving the top 48, and inner core die 58 in direction A. The inner core die 58 is lowered within the bottom 56 of the mold 44. Next, the top 48 and the bottom 50 of the molding machine 42 are brought together. The pistons 53 or other mechanical devices may be used to bring the top 48 together with the bottom 50. It is clear that top members may be moved in direction A and/or bottom members moved in direction B to bring the top 48 and bottom 50 together. Bringing the top 48 together with the bottom 50 also brings the top 54 of the mold to meet the bottom 56. Now the injection mold 44 is closed.

Injection mold material such as heated liquid airbag cover rubber composite material is then pumped into the mold 44 through an opening (Not Shown). Pressure used to inject the material causes the liquid material to fill all the grooves and interior portion of the mold 44. The material surrounds the surface 62 of the inner core die 58 exposed within the mold 44. The material also preferably surrounds the window mold members 60.

The mold material is then allowed to solidify. This may be done by curing, cooling, baking, or other techniques which depend on the nature of the mold material being used. For example, with airbag covers 16 the injection material is generally a hot liquid rubber composite. Therefore, with airbag covers 16, the solidifying step requires that the material be cooled for a period of time.

Next, the mold 44 is opened in direction B. The mold 44 may be opened by pistons 53. The pistons 53 may extend to separate the top 48 from the bottom 50. Because the mold top 54 and mold bottom 56 are anchored to the top 48 and bottom 50 of the injection mold machine 42, separating the top 48 from the bottom 50 also separates the mold top 54 and mold bottom 56.

Next, rods 52 move to separate the inner core die 58 from the bottom 56. Generally, the inner core die 58 is moved in direction B perpendicularly away from the bottom 56. In this manner, the molded piece 46 is separated from the bottom 56. At this point the molded piece 46 is secured to the inner core die 58 due to bias and shrinkage caused by cooling the material. Additionally, the molded piece 46 is secured because the window mold members 60 prevent removal in direction B of the molded piece 46 without damaging or deforming the molded piece 46.

To remove the molded piece 46 without damage or deformation, the window mold member 60 should be moved out of the window 36 such that the molded piece 46 is free to move off the inner core die 58 in direction B. Conventionally, this may be done using levers and other mechanisms internal to the inner core die 58 such that the window mold member 60 is retracted from the window 36. These additional interior parts are prone to wear and may cause production down time to repair or replace.

Alternatively, the interior wall 32 may be manually separated from the surface 62 such that the molded piece 46 may then be removed in direction B without damaging the windows 36 or deforming the molded piece. Conventionally, fabrication of molded pieces such as airbag covers 16 are removed from the inner core die 58 through manual labor. Generally, a worker inserts specially designed tools for lifting the interior wall 32 away from the surface 62 around the perimeter of the inner core die 58. Because inner core dies 58 and window 36 locations generally differ with each molded piece 46, often new tools must be made to allow the worker to removed the different molded piece 46. This requirement for new special tools may be referred to as re-tooling. The re-tooling costs as well as the delay and costs of using manual labor to remove the molded piece 46 are limitations of conventional injection molding.

One embodiment of the present invention includes a pair of ramps 64 to overcome the limitations described above. The ramps 64 are part of the window mold members 60. The ramps 64 may be formed when the inner core die 58 is fabricated.

The ramps 64 are described in more detail below. Essentially, the ramps 64 provide a pair of parallel inclines that separate the interior wall 32 from the surface 62. In one embodiment, the inner core die 58 is held stationary while lifting rods 52 move in direction B to remove the molded piece 46 from the inner core die 58. Alternatively, the inner core die 58 may be moved in direction A while the rods move simultaneously in direction B.

The ramps 64 separate the interior wall 32 from the surface 62 such that the window 36 is unobstructed by the window mold member 60. In this manner, the molded piece 46 may be operably removed from the inner core die 58 without manual intervention or additional moving parts.

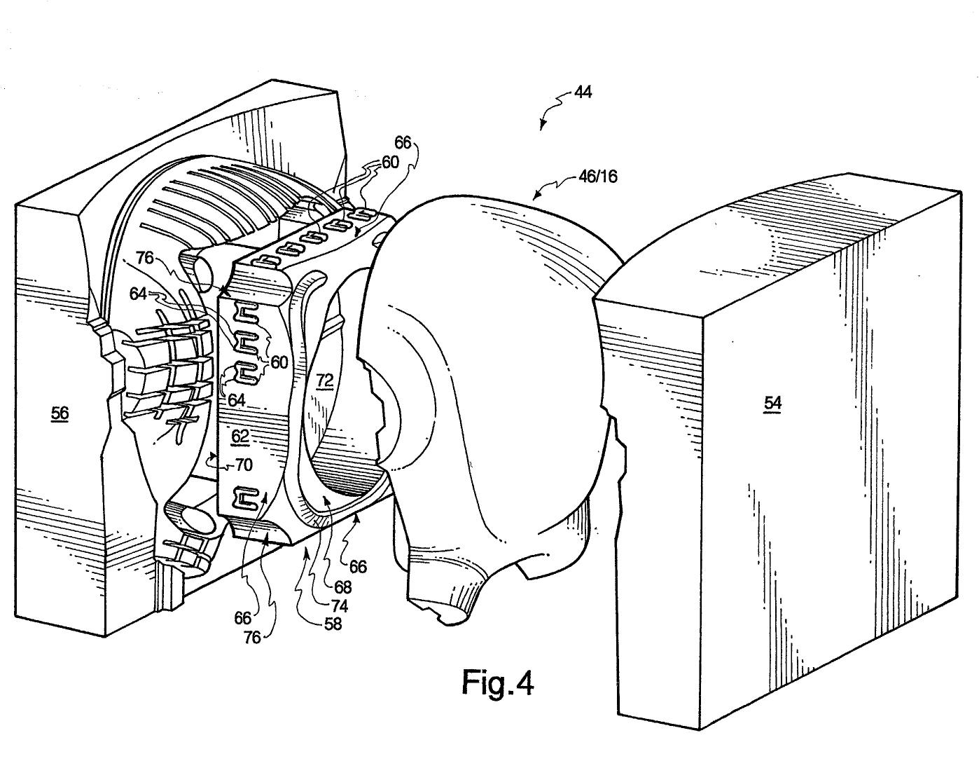

Referring now to FIG. 4, a perspective view of an injection mold 44 suitable for fabricating airbag covers 16 is illustrated. A molded piece 46 in the form of an airbag cover 16 is also illustrated. The top 54 and bottom 56 of the mold 44 form respectively the front and back of the airbag cover 46, 16.

The inner core die 58 is illustrated in an extended position from the bottom 56. The inner core die 58 is generally a three dimensional structure made from metal. Alternatively, other materials such as wood, rock, and the like may be used. The inner core die 58 may be of a variety of shapes including a cube, a prism, a cone, a torroid, or other geometric shape. The inner core die 58 may include one or more sides 66.

In the illustrated embodiment, the inner core die 58 is shaped as a prism having four sides 66 joined to form a substantially square front 68 and a substantially square back 70. Alternatively, the front 68 and back 70 may have a substantially rectangular shape. Generally, the back 70 is attached to the injection molding machine 42 by rods 52. The front 68 is generally unattached. The front 68 may include one or more cavities 72 and/or protrusions 74 for forming corresponding protrusions and cavities in the back of the airbag cover 46, 16.

As discussed above, the inner core die 58 also includes an exterior surface 62 for forming an interior wall 32 of the airbag cover 46, 16. Preferably, disposed on the surface 62 are a plurality of window mold members 60, each preferably made from metal. Alternatively, the window mold members 60 are made from stone, wood, or other rigid material.

Window mold members 60 project from the surface 62 to prevent mold material from depositing between the window mold member 60 and an interior side wall (Not Shown) of the bottom 56 of the mold 44. In this way, a window 36 is formed in an interior wall 32 of the airbag cover 46, 16 when mold material is injected into the closed mold. One or more window mold members 60 may be included on each side 66 of the inner core die 58.

Referring still to FIG. 4, the window mold members 60 preferably include a pair of ramps 64. In the illustrated embodiment, the ramps 64 are positioned on an end of the window mold member 60 that faces the bottom 56 part of the mold 44. Generally, the ramps 64 are parallel to each other. With the inner core die 58 in the extended position, as illustrated, the ramps 64 separate the interior wall 32 from the surface 62 to allow the airbag cover 46, 16 to be removed from the inner core die 58 without damaging the plurality of windows 32.

Preferably, the inner core die 58 includes corners 76 configured to aid automated removal of the molded piece/airbag cover 46, 16 from the inner core die 58. Preferably the corners 76 are concave shaped. Alternatively, the corners 76 may be inverted corners 76. Generally, inverted corners 76 are those in which the intersection of the sides 66 forming the corner 76 occurs within the general perimeter of the object. Concave corners 76 allow an interior wall 32 to flex and bend more easily than with a non-inverted corners 76. The increased pliability of the interior wall 32 provides for easier separation from the surface 62 as the airbag cover 46, 16 is separated from the inner core die 58 according to the present invention.

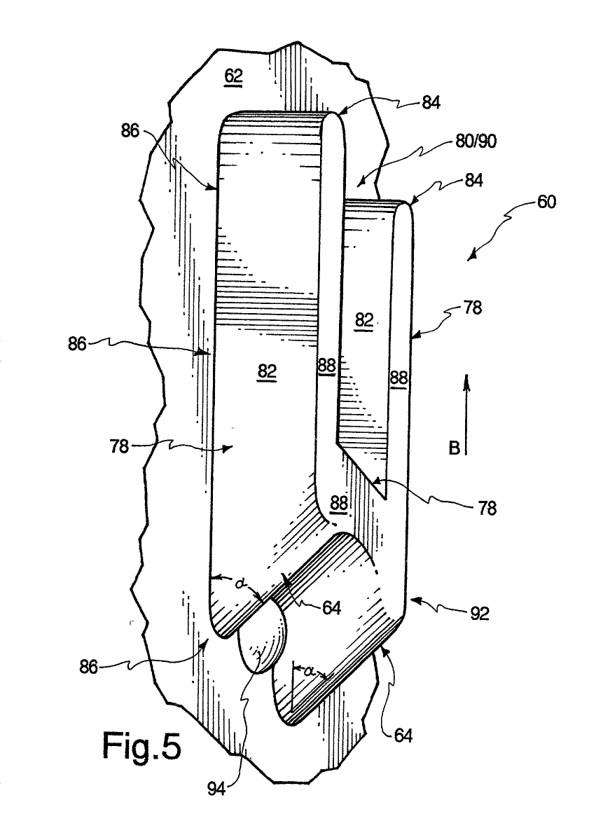

Referring now to FIG. 5, a perspective view of one embodiment of a window mold member 60 is illustrated. The window mold member 60 is illustrated as attached to the surface 62 of a cut-away portion of the inner core die 58 (Not Shown).

Generally, a window mold member 60 is machined from a same piece of material as the inner core die 58. Alternatively, the window mold member 60 may be made of different material and attached to the surface 62 by welding, gluing or other securement techniques.

In one embodiment, the window mold member 60 includes three walls 78 connected to form a block “U”. The open end 80 of the “U” allows for the formation of the tab 40 in a molded piece 46. Alternatively, the window mold member 60 may include one wall 78 to form a slot in the interior wall 32 of the molded piece 46. Additionally, two or more walls may be connected such that windows 36 of various geometric shapes are formed in the interior wall 32. These geometric shapes may have an open 80 or a closed end.

Each wall 78 is shaped and sized in relation to the desired shape and size of the opening defining the window 36 of the molded piece 46. Preferably each wall 78 includes two straight sides 82 with rounded ends 84. Generally, each wall 78 includes a base 86 and a top 88. Preferably, the base 86 is attached to the surface 62 and the top 88 is an unattached flat member. The flat top 88 allows for close contact with a generally flat side wall (Not Shown) of the bottom 56 of the mold 44 when the inner core die 58 is lowered within the bottom 56 in preparation for molding a new piece 46.

FIG. 5 includes indications of a top 90 and bottom 92 ends of the window mold member 60. The top 90 and bottom 92 are indicated simply for explanation purposes. The top 90 and bottom 92 do not dictate the configuration and layout of the walls 78 of the window mold member 60. In the illustrated embodiment, two walls 78 are perpendicular to the top 90 and parallel to each other. The two walls 78 are connected perpendicularly to a third wall 78 marking the bottom 92 of the window mold member 60.

In a preferred embodiment, the window mold member 60 includes a pair of ramps 64 attached to the bottom 92 end. Generally, the bottom end 92 is the end which the molded piece 46 is moves away from for removal from the inner core die 58. The ramps 64 are generally parallel to each other because the walls 78 to which they are attached are parallel. Alternatively, the ramps 64 may run along various angles in relation to each other.

Preferably, the ramps 64 run from the surface 62 toward the flat top 88 at an angle alpha. Preferably, angle alpha is between zero and ninety degrees. The ramps 64 form an incline along the bottom end 92 of the window mold member 60.

FIG. 5 illustrates ramps 64 used with window mold members 60. However, it is contemplated within the scope of the present invention that ramps 64 may be used on other protruding members within a mold 44. For example, a mold 44 may include a large protrusion relative to the size of the mold 44. The protrusion may include ramps 64 on a side of the protrusion opposite the direction of motion used to remove the molded piece. Therefore, the scope of the present invention is not limited to window mold members 60. FIG. 5 merely illustrates one embodiment of ramps 64.

The incline of the ramps 64 allows the interior wall 32 surrounding the inner core die 58 to be removed without additional moving parts or extra effort from a worker. The ramps 64 operate in the injection molding process when the molded piece 46 is to be removed from the inner core die 58. At this point, described earlier, the injection material has solidified around the window mold member 60. The material around the window mold member 60 comprises the interior wall 32. To remove the molded piece 46 from the inner core die 58, the interior wall 32 should be separated from the surface 62 to free the newly formed window 36. The distance of separation should be about the thickness of the interior wall 32. The thickness of the interior wall 32 is generally equal to the distance between the base 86 and the top 88 of the wall 78. Preferably, the molded piece 46, and therefore interior wall 32, are moved in direction B in relation to the window mold member 60.

Conventionally, the window mold member 60 may be retracted to free the new window 36. Alternatively, the interior wall 32 is bent using special tools in a direction perpendicular to direction B and away from the surface 62. The use of these tools and additional parts increase costs and slow production.

According to one embodiment, the ramps 64 provide an incline along the bottom 92 of the window mold member 60. As the interior wall 32 is moved in direction B, the incline causes the material of the interior wall 32 contacting the ramps 64 to slide up the ramps 64 towards the top 88 of the walls 78. This causes the material between the two ramps 64 to also travel up the incline and separate from the surface 62. The interior wall 32 around the window mold member 60 travels from the base 86 of the wall 78 to the top 88. Once at the top 88, the window 36 and surrounding interior wall 32 material is unobstructed in its ability to move in direction B. The interior wall 32 then slides along the top 88 and the molded piece 46 is removed. The ramps 64 provide an incline that allows the molded piece 46 to be removed without additional worker labor or moving parts.

Referring still to FIG. 5, one embodiment includes a boss 94 to help lift the interior wall 32 over the window mold member 60. A boss 94 is preferably a structure attached to the surface 62 and positioned between the ramps 64. The boss 94 is preferably positioned in close proximity to the wall 78 on the bottom end 92 of the window mold member 60. Generally, the boss 94 is in the shape of a half-sphere. Alternatively, the boss 94 may also be in the shape of an incline running from the base 86 to some point on the side 82 of the wall 78. This point may lie between the base 86 and the top 88 or may be at the top 88. The shape of the boss 94 allows it to function in a similar manner to the ramps 64.

The size of the boss 94 depends on the size of the walls 78 and ramps 64. Generally, the boss 94 does not extend from the bottom 92 of the window mold member 60 along the surface 62 beyond the beginning point of the ramps 64. The height the boss 94 extends from the surface 62 depends on the height of the walls 78. Preferably, the height of the boss 94 is up to about half the height of the walls 78.

Generally, if the height of the boss 94 is beyond one-half the height of the walls 87 or if the pair of ramps 64 are replaced by a single incline running the width to the wall 87 on the bottom 92 of the window mold member 60, then a “feather edge” on the window 36 can result. A feather edge is generally a portion of the injection mold material that tapers from a first thickness to a very fine edge having substantially no thickness. With injection molding for applications such as with airbag covers 16, a feathered edge is undesirable.

As mentioned above, in airbag covers 16 the window 36 is generally used to secure the airbag cover 16 to a housing 22. The structural member of a window 36 bearing a majority of the force to secure the airbag cover 16 against a penetrating airbag 18 is formed by the wall 78 along the bottom 92 of the window mold member 60. If the structural member is feathered, or very thin, then the structural integrity and performance ability of this member is compromised. Therefore, the height of the boss 94 and configuration of the ramps 64 are preferably limited to avoid forming a feathered edge on the window 36.

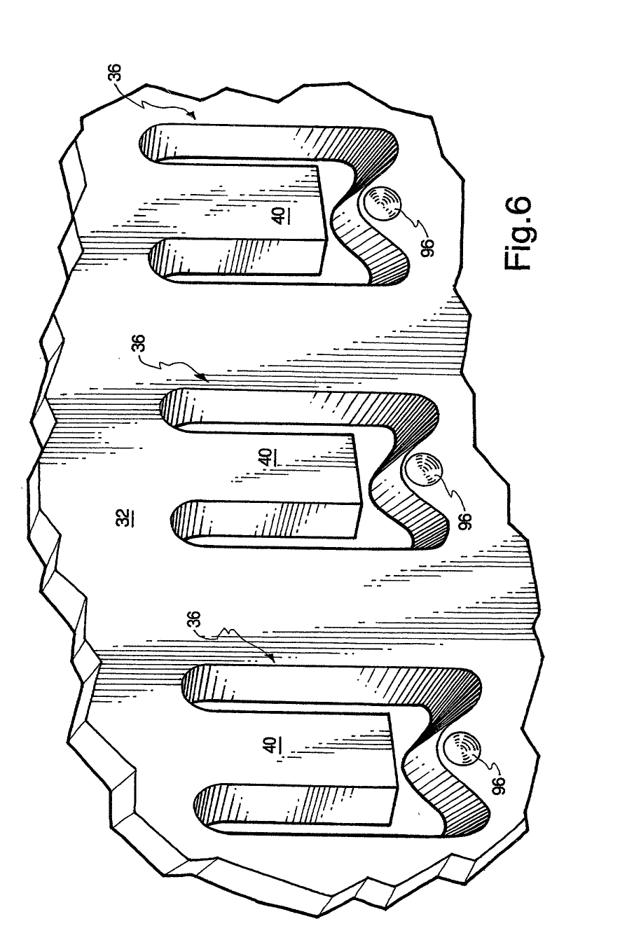

Referring now to FIG. 6, a portion of an interior wall 32 including a plurality of windows 36 is illustrated. These windows 36 are the product of the shape and structure of window mold members 60 such as the one illustrated in FIG. 5.

In one embodiment, the window mold members 60 form a window 36 in the shape of a block “U”. Tabs 40 for securing hooks 34 (See FIG. 2) within the window 36 are also illustrated. At the corners of the “U” there is a slight tapering of the interior wall 32 created by the slope of the ramps 64. An impression 96 formed by the boss 94 is also illustrated. However, the material along the majority of the edge forming the bottom leg of the “U” is substantially the same thickness as the remainder of the interior wall 32. The slope of the ramps 64 facilitated removal of the interior wall 32 from the surface 62 and a feathered edge along the bottom of the “U” has been avoided.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by Letters Patent is:

1. An injection mold inner core die comprising:
a window mold member projecting from a surface of the inner core die and configured to define a window in an interior wall of a piece being molded by the die, wherein the window mold member is configured to separate the interior wall of the piece being molded from the surface when the molded piece and inner core die are separated.

2. The injection mold inner core die, as in claim 1, wherein the window mold member has a flat top.

3. The injection mold inner core die, as in claim 1, wherein the window mold member comprises a pair of ramps which slope outwardly from the surface of the inner core die.

4. The injection mold inner core die, as in claim 3, wherein the ramps are generally parallel.

5. The injection mold inner core die, as in claim 3, wherein the ramps run from the surface to a flat top.

6. The injection mold inner core die, as in claim 1, wherein the window mold member is made of metal.

7. The injection mold inner core die, as in claim 1, wherein the pair of ramps are located on an end of the window mold member which is opposite a direction of motion of the piece being molded with respect to the inner core die when the molded piece is separated from the inner core die.

8. The injection mold inner core die, as in claim 1, wherein the window mold member comprises a boss disposed between the ramps to facilitate separation of the interior wall from the surface.

9. The injection mold inner core die, as in claim 8, wherein the boss is configured as a half-sphere attached to the surface.

10. The injection mold inner core die, as in claim 8, wherein the boss is positioned between parallel ramps.

11. The injection mold inner core die, as in claim 8, wherein the boss is configured as an incline plane.

12. The injection mold inner core die, as in claim 1, further comprising a plurality of window mold members configured to form a plurality of windows.

13. An injection mold inner core die comprising:
a window mold member projecting from a surface of the inner core die and configured to define a window in an interior wall of a piece being molded by the die, wherein the window mold member is configured with at least two parallel ramps connected to the window mold member

14. The injection mold inner core die, as in claim 13, wherein the window mold member has a flat top.

15. The injection mold inner core die, as in claim 14, wherein the ramps run from the surface to the flat top.

16. The injection mold inner core die, as in claim 13, further comprising a boss positioned between the ramps.

17. The injection mold inner core die, as in claim 13, wherein the inner core die has inverted corners.

18. The injection mold inner core die, as in claim 13, wherein the inner core die is rectangular in shape.

19. The injection mold inner core die, as in claim 13, wherein a plurality of window mold members are disposed on the surface.

20. An airbag injection mold inner core die, comprising:
a back connected to an injection mold;
a front,
one or more sides to connect the front to the back,
a window mold member disposed on a side and configured to form a window within a wall of a molded airbag cover; and
a pair of ramps connected to the window mold member and configured to slope from the front toward the back.

21. An airbag injection mold inner core die, as in claim 20, further comprising a plurality of window mold members disposed on each side.

22. An airbag injection mold inner core die, as in claim 21, further comprising a boss connected to the side and positioned between the ramps.

23. An airbag injection mold inner core die, as in claim 22, wherein one side meets another to form a concave corner.

24. A method for fabricating an airbag cover comprising openings disposed within an interior wall, comprising:
providing an airbag injection mold comprising an inner core die configured with a front connected to four sides which are connected to a back, wherein one or more window mold members are disposed on the sides, and wherein the window mold members comprise a pair of ramps and a boss connected to the window mold members at a point closest to the back;
injecting a liquid airbag cover material into the mold;
cooling the liquid airbag cover material to form a pliable rigid airbag cover;
raising the inner core die from an outer core die such that the airbag cover remains secured to the inner core die;
separating the airbag cover from the inner core die.

25. A method as in claim 24, wherein separating comprises holding the inner core stationary while moving the airbag cover away from the inner core.

26. A method as in claim 24, wherein separating comprises moving the inner core in a first direction while moving the airbag cover in a second direction.

27. A method as in claim 24, wherein the four sides connect to each other to form inverted corners.

28. A method as in claim 24, wherein the inner core is rectangular shaped.
